(19) United States
(12) Patent Application Publication
(10) Pub. No.: US 2005/0058016 A1
(43) Pub. Date: Mar. 17, 2005

(54) Method to blend two or more fluids

(76) Inventors: Morris E. Smith, Cumming, GA (US); Albert L. Ruff, Lawrenceville, GA (US); Elvis E. Mitchell, Acworth, GA (US)

Correspondence Address: THE LUBRIZOL CORPORATION;Mail Drop 022B, Patent Administrator, 29400 Lakeland Boulevard, Wickliffe, OH, 44092-2298, US

(21) Appl. No.: 10/662,706

(22) Filed: Sep. 15, 2003

(51) Int. Cl. G05D 11/02

(52) U.S. Cl. 366/152.1

(57) ABSTRACT

A blending system that accurately produces the desired predetermined fluid composition by continuously monitoring each fluid components mass or volume flow.

### FIELD OF USE

The invention relates to a method of blending two or more fluid components. In particular the invention relates to a blending method that accurately achieves desired component ratios by continuously monitoring the mass or volume flow rates throughout the blending delivery system and constantly comparing the total delivered amount of each component against the desired recipe for component concentrations.

### BACKGROUND OF THE INVENTION

There are many apparatus for blending two or more fluid components. The use of blenders to continuously mix two or more components to achieve a final composition of determined concentrations is known. Current continuous blenders achieve the desired component ratio(s) in the final composition by using control methods that attempt to control the blend ratio in “real-time” throughout the entire delivered volume. As the components are flowing, a controller uses a control-method, which is an algorithm typically implemented by software that continuously and essentially instantaneously varies valves, positive displacement pumps and/or other flow control means, based on mass or volume flow information, to constantly maintain the desired blend ratio at the blender output. A known method is disclosed in U.S. Pat. No. 4,876,053, which teaches a blending system utilizing individual closed loop control under an algorithm for comparing the ratio of actual accumulated volumes of the fluids relative to a statistical determined ratio of ideal volume of each component for a pre-selected blend ratio.

A problem with known blending methods is that the over-all accuracy of the resulting component composition is only as exact as the instantaneous control accuracy of the hardware. In general, control valves, positive displacement pumps and other flow control means have less control accuracy at the low end of their operating range resulting in poor instantaneous accuracy at low flow rates. Thus, the blend systems using the known control method have low blend accuracy when continuously blending at low flow rates. Additionally, the overall accuracy of the blend is affected at high flow rates when flow start-up of a delivery sequence is considered. Therefore, existing control methods rely upon a large batch size, the blended volume during a particular operating period, delivered over a relatively long period to “average out” the errors encountered at flow start-up.

There is a need for a blending method that overcomes the instantaneous accuracy limitations of the current blender control methods. The present invention is a novel method that overcomes the instantaneous accuracy limitations of the known blender control methods. This novel method continuously monitors and stores mass or volume flow information from the start of the blending process, that is, the start of a particular operating period, and continuously compares the concentration of the component in the total blended volume against the desire recipe for fluid concentrations, and, should the concentration of one or more of the components drift from the prescribed recipe, this method controls and adjusts the delivery rates to bring the total delivered volume into compliance, even if that causes the instantaneous ratio to fall outside of normal accuracy limits.

An advantage of the invention over the known methods is that corrections are made for the delivery accuracy errors at very low flow rates. This is important not only when continuously blending at low flow rates, but the method compensates for poor instantaneous accuracy at start-up and quickly brings the total blended volume into compliance with the desired fluid recipe. Unlike the current blender control methods, the present invention does not rely on a large batch size to “average out” errors encountered at start-up. Hence, the invention allows blenders to have greater blend accuracy at relatively low flow rates and allows blenders to deliver smaller batches with tighter accuracy tolerances when compared to blenders using current control methods.

### SUMMARY OF THE INVENTION

The object of the present invention is to provide a blending method that overcomes the instantaneous accuracy limitations of current blender control means. Another object of the invention is to provide a blending method which monitors and stores mass or volume flow information from the start of delivery and constantly compares component concentration in the blended volume against the desire recipe of component concentrations.

To achieve these objects the present invention provides a method to blend two or more fluid components, wherein N is the number of fluid components comprising:
(a) continuously measuring, accumulating and storing flow information on at least N-1 fluid components to be blended since the start of a blending process,
(b) calculating the concentration of at least N-1 fluid component in the total blended volume of fluid,
(c) continuously comparing the calculated concentration of the fluid components in the total blended volume against a blend recipe for fluid component concentrations, and
(d) continuously adjusting flow rates for at least one fluid component to achieve the desired concentration of each component in the total blended volume,
whereby continual control of the concentration of the measured fluid component in the total blended fluid volume. The composition of this invention is blended in the following apparatus for blending two or more fluid components comprising:
(a) at least two inlets that supply the individual fluid components into the blender,
(b) piping for transporting the components through at least one mixing location,and transporting the blended fluid to a blender output;
(c) a means for measuring flow through the piping such that the flow of each individual component can be calculated;
(d) a means for controlling flow rates such that the flow of each individual fluid component from the at least two inlets can be independently varied to control the concentration of the individual components in the blended fluid at the output of the blender; and
(e) a blender controller suitable for executing a control method, wherein the controller is adapted to:
   (i) receive information to start the blending process,
   (ii) continuously measure, accumulate and store flow information since the start of a blending process, and calculating the concentration of one of the following, each fluid component, each fluid component except one, in the total blended volume of fluid,
   (iii) continuously compare the calculated concentration of the components in the total blended volume against a recipe for component concentrations, and
   (iv) continuously adjust flow rates to achieve and maintain the desired concentration of each component in the total blended volume since the start of the blending process,
      resulting in a blending system capable of accurately blending two or more components to a desired blend recipe.

The composition of this invention is blended using the method of blending two or more blend components comprising:
(a) receiving information about a blend recipe into a system control means;
(b) initiating a flow of individual components by the system control means to a prescribed blend ratio from the blend recipe;
(c) continuously measuring flows and calculating concentrations of the individual components in the total blended volume since the initiation of fluid flow;
(d) continuously comparing the metered concentrations to the concentrations of the blend recipe and continuously adjusting flow rates based upon the comparisons to achieve and maintain the blend recipe concentrations; and
(e) terminating the flow of the components based upon at least one of the following: having reached a total blended volume that is at least the desired batch size, receiving an input signal to terminate blending.

The method of the invention can be used in blend systems designed for a variety of applications including but not limited to ethanol blending into gasoline, methanol blending into gasoline, methanol/butyl alcohol blending into gasoline, multi-component alcohol blending into gasoline, butane blending into gasoline, ethyl-hexyl nitrate into diesel fuel, gasoline grade blending (i.e., premium gasoline blended with regular gasoline to make mid-grade gasoline), dimethyl ether blending into diesel fuel, multi-component blending into diesel fuel, multi-component blending into heating oil, oxygenate blending, gasoline into alcohol (for denaturing), RVP blending, emulsified fuels, hydraulic and gear fluids, and various other industrial fluids, and the like.

### BRIEF DESCRIPTION OF THE DRAWINGS

FIG. 1 is a schematic diagram of one embodiment of a blending system capable of blending one fluid component with another fluid component.

FIG. 2 is a flow chart illustrating an embodiment of the method of the present invention relating to a method for operating the blender of FIG. 1.

FIG. 3 is a schematic diagram of another blending system capable of blending two fluid components.

FIG. 4 is a flow chart illustrating another embodiment of the method of the present invention for operating the blender of FIG. 3.

### DETAILED DESCRIPTION OF THE INVENTION

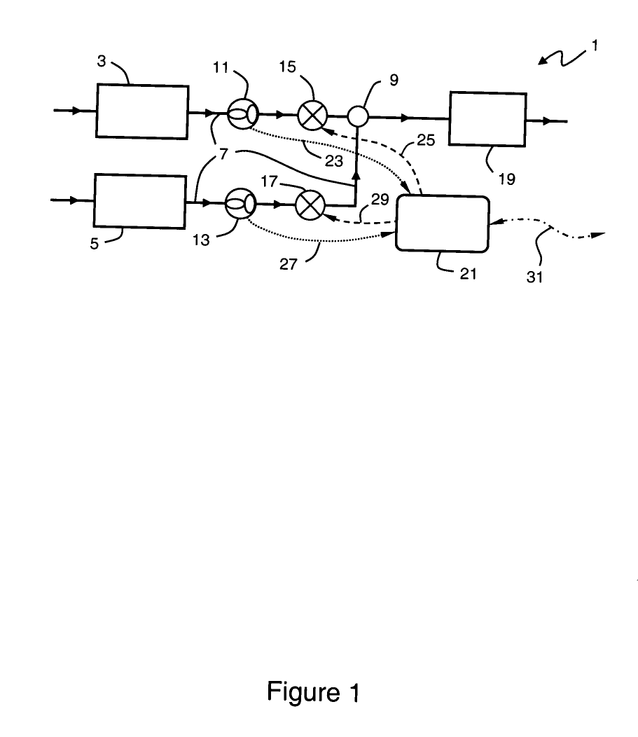

With reference to FIG. 1, blending apparatus 1 is shown that includes two fluid component inlets 3, 5, piping 7, blending location 9, meters 11, 13 and valves 15, 17 in the piping, blender output 19 and blender controller 21. As used herein, a fluid component is any material or mixture of materials that can flow, and which flow can be measured by, either volume or mass, and further can be controlled. Fluid components include, but are not limited to liquids, gasses solid particulates and mixtures thereof, in particular chemicals, fuels, fluid, additives, lubricant oil and the like. Exemplary components include but are not limited to ethanol, methanol, methanol/butyl alcohol, multi-component alcohol, butane, ethyl-hexyl nitrate, gasoline, dimethyl ether heating oil, oxygenate blending, gasoline into alcohol (for denaturing), gasoline, diesel fuel, emulsified fuel and mixtures thereof. The blender inputs 3, 5 connect to storage tanks, pipe lines or other fluid providing means (not shown) that supply the blender location 9 with the individual fluid components to be blended. Inputs 3, 5 may each include a pump, a manual isolation valve, a check valve, filters, connector and/or other devices that are known in the art. The piping 7 transports the individual fluid components from the individual inlets 3, 5 to blending location 9 and the blended fluid components from the blending location 9 to the blender output 19. Blender output 19, which may include pump, manual isolation valve, check valve, filters, connector and/or other devices that are known in the art, is where blended fluid exits blender apparatus 1 and is typically connected to an appropriate device such as a storage tank, a delivery tank, a pipe line or other receptacle while the blender is in use. Blending location 9 is where the two individual fluid components from inlets 3, 5 are mixed. The mixing may occur by merging the two fluid streams. Meter 11 and valve 15 are located in piping 7 between inlet 3 and blending location 9. Meter 11 measures the amount, which can be either a volume or mass, of fluid component supplied from inlet 3 that flows through piping 7 and provides an output of the amount measured to blender controller 21 through communication conduit 23. Whether mass or volume flow of the fluid component is measured depends upon the type of meter used. Valve 15 controls the flow of fluid component from inlet 3 through piping 7 to blending location 9 as determined by an output signal from blender controller 21 through communication conduit 25. That is, signals can be sent to valve 15 to increase, decrease or stop the flow of fluid from inlet 3. Similarly, meter 13 and valve 17 are located in piping 7 between inlet 5 and blending location 9. Meter 13 measures the amount, which can be either a volume or mass, of fluid component supplied from inlet 5 that flows through piping 7 and provides an output of the amount measured to blender controller 21 through communication conduit 27. Valve 17 controls the flow of fluid component from inlet 5 through piping 7 to blending location 9 as determined by an output signal from blender controller 21 through communication conduit 29. Blender controller 21 receives signals from meters 11, 13 and provides output to valves 15, 17 based and inputs and/or outputs information with external devices(not shown) such as a computer, key pad, switch, monitor, sensor, mechanical preset, electronic preset, programmable logic controller (PLC), terminal automation system (TAS) or other, through information conduit 31.

With continued reference to FIG. 1, in blender controller 21 of blender apparatus 1 receives information through conduit 31, which can include blend recipe, batch size, start and finish of blend process and other information. Based on that information and a above described method, which is typically implemented by software stored in blender controller 21, the blender controller 21 monitors meters 11, 13 and control valves 15, 17 to achieve the desired concentration of the two fluid components supplied from inputs 3, 5 in the blended fluid delivered from blender apparatus 1 at blender output 19. Blender controller 21 reports information about the blend process and the blended fluid during and/or after the blending process through conduit 31 to provide information outputs for process operators and/or to document the blending-process/blended-fluid.

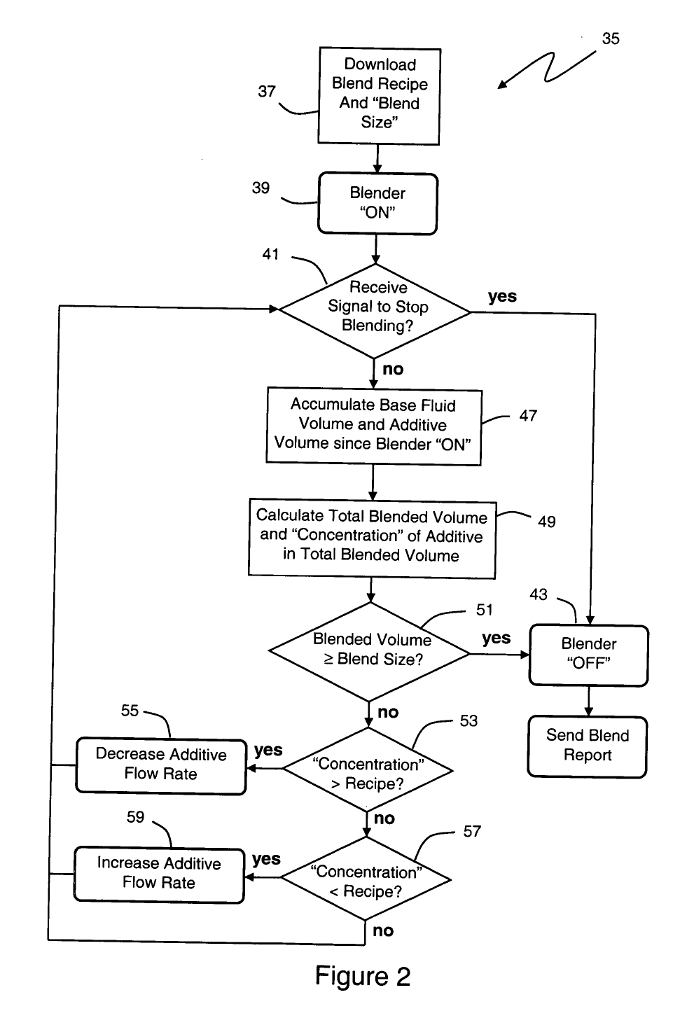

FIG. 2 show a flow chart of blend method 35, which is one embodiment of the present invention that can be used with blender apparatus 1 of FIG. 1 to provide improved blend accuracy for blended fluid of any batch size. Blend method 35 begins in block 37 when a blend recipe, which specifies the concentration of the two fluid components in the blended fluid output of the blender, and a batch size, which specifies the total amount of fluid to be produced by the blender during the blending process, is downloaded to the blender controller 21 through a communication conduit 31 from one or more input devices such as a key pad, programmable logic controller (PLC), terminal automation system (TAS), or other input devices known in the art. For example, in blender apparatus 1 of FIG. 1 the information is downloaded to blender controller 21 from device(s) (not shown) through communication conduit 31 to blender controller 21. After receiving the blend recipe, method 35 proceeds to block 39 where either from receiving a separate signal or automatically after the information is received the method commands the blender controller 21 to turn the blender “on” by sending signals to the blender valves. For example blender controller 21 sends signals to valves 15 and 17 to allow the appropriate flow of the fluid components to be blended. Method 35 determines in block 41 if the controller has received a signal to stop blending. The blender controller 21 may receive a stop signal from an input device such as a switch, sensor, key pad, programmable logic controller (PLC), terminal automation system (TAS), or other input devices known in the art. Various reasons to stop blending include an equipment failure, a stop in the supply of one of the fluid components, blender output exceeding the capacity of the receptacle receiving the blended fluid, detection an unsafe blending condition and completion of the blend recipe. If the determination in block 41 is “yes”, then in block 43 method 35 commands the blender controller 21 to turn the blender “off” by sending signals that stop the flow of all fluid components such that there is no output from the blender. For example, blender controller 21 of FIG. 1 send signals to valves 15, 17 to close. Further, in block 45 method 35 commands the blender controller 21 to send a report that can indicate that the blend process has stopped and/or that documents the batch of fluid blended. For example blender controller 21 of FIG. 1 could send an audible or visual signal using communication conduit 31, that is heard or seen by an operator or a report could be sent, that details the amount of fluid blended, concentrations of the fluid components, and/or other information to a monitor, a printer, a TAS, and/or other information display, storage or analysis device. If the determination in block 41 is “no”, method 35 in block 47 commands the blender controller 21 to accumulate and store the amount of each fluid component delivered through the blender since the blender was turned “on”. The, blender controller 21 of FIG. 1 using communication conduits 23 and 27 monitors the outputs of meters 11 and 13 respectively to accumulate and store the total amounts of fluid components delivered through inputs 3 and 5 respectively since the blending process for a particular batch began. For example, the fluid component delivered by input 3 is defined herein as the base fluid, and the fluid component delivered by input 5 is defined herein as the “additive”. Hence, in block 47 method 35 accumulates and stores the total amount of base fluid and additive delivered since the blender was turned “on” in block 39. In block 49, method 35 calculates the total blended volume since the blender was turned “on” and the concentration of additive in the total blended volume using the accumulated amounts of base fluid and additive stored in block 47, and in block 51 the method 35 determines if the calculated total blended volume is greater than or equal to the batch size downloaded in block 37. If the determination is “yes” then in block 43 method 35 commands the blender controller 21 to turn the blender “off”, and in block 45 to send a blend report. If the determination of block 51 is “no”, in block 53 method 35 determines if the additive concentration is greater than that required by the recipe downloaded in block 37. If the determination is “yes”, in block 55 method 35 commands the blender controller 21 to send a signal to decrease the flow of additive in the blender, for example controller 21 of FIG. 2 sends a signal to valve 17 to reduce the additive flow through inlet 5. If the determination of block 53 is “no”, in block 57 method 35 determines if the additive concentration is less that that required by the recipe, and if the determination is “yes”, in block 59 the method 35 commands the controller send a signal to increase the additive flow in the blender. If the determination of block 57 is “no”, then method 35 does not command a change in the additive flow. If the additive flow rate is decreased in block 55, increased in block 59 or remains the same due to a “no” determination in block 57, the method 35 returns to block 41 and the steps of determining if a “stop” signal was received, accumulating and storing total base fluid and additive since the blender was turned “on”, calculating total blended volume and additive concentration in the total blended volume, comparing total volume and concentration to the downloaded information and, if necessary, adjusting the flow of additive continues until method in block 41 receives a signal to stop blending or until the total volume blended equals or exceed the desired batch size in block 51. In this manner method 35 assures that the concentration of additive in the total amount blended, independent of batch size, is the amount specified in the recipe downloaded in block 37 even though at any instant the concentration of additive in blender output 19 may be greater or less than the desired recipe concentration since instantaneous concentration information is not used in calculation in block 49 or the determinations of blocks 53 and 57. Further, method 35 is not limited by a blender's ability to be instantaneously controlled since the method is continuously controlling the additive flow rate base on total component deliveries since the blender is turned “on” in block 39.

Method 35 of FIG. 2 controls the concentration of the additive by varying the additive flow rate, another embodiments of the invention may in block 55, 59 increase or decrease respectively the flow of the base fluid to achieve the desired change in additive concentration, or may vary the flow of both the base fluid and the additive to achieve the desired concentration of the additive in the output of a batch of fluid from a blender of the type shown in FIG. 1.

Method 35 of FIG. 2 calculates and compares the concentration of the additive to the downloaded blend recipe, it is understood that this is calculating and comparing the base fluid concentration.

FIG. 1 shows blender apparatus 1 with meters and valves that measure and control flow respectively for the individual fluid components in the piping 7 before blend location 9. The method of this invention is not limited to having all meters and flow control means located before the blending location 9. The meters and valves need only be located such that from one or more meter outputs the concentration or each individual fluid component can be measured and controlled to achieve a desired blend recipe in the fluid output of the blender.

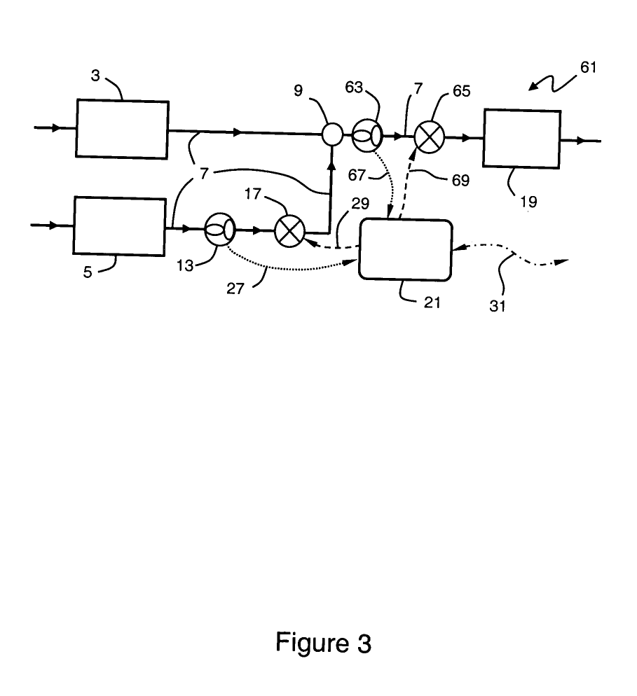

FIG. 3 is blender apparatus 61 where components that are the same as the blender apparatus 1 of FIG. 1 are numbered the same. Blender apparatus 61 includes two fluid component inlets 3, 5, piping 7, blending location 9, meters 13, 63 and valves 17, 65 in the piping, blender output 19 and blender controller 21. Meter 63 and valve 65 are in piping 7 between blend location 9 and output 19 such that the meter measures and the valve controls the flow of the blended amount, which can be either a volume or mass, of the two fluid components supplied to inlets 3, 5 that flow through piping 7 to outlet 19. Information of the amount of fluid measured by meter 63 is communicated to blender controller 21 through conduit 67. Blender controller 21 controls valve 65 by outputs to the valve communicated through conduit 69. Meter 13 and valve 17 measures and controls respectively the flow of the fluid component, for example the additive, delivered through inlet 5.

Blender apparatus 61 of FIG. 3 operates similar to blender apparatus 1 of FIG. 1 except the blend method calculates the concentration of the additive using accumulated and stored total amounts as in the present invention, from measured amounts of blended fluid, with meter 63, and one of the components, with meter 13, instead of from measured amounts of the two components individually. Also the blend method for blender apparatus 61 controls the concentration of the additive by controlling the total flow with valve 63 and/or by controlling the flow of the additive from input 5 with valve 11.

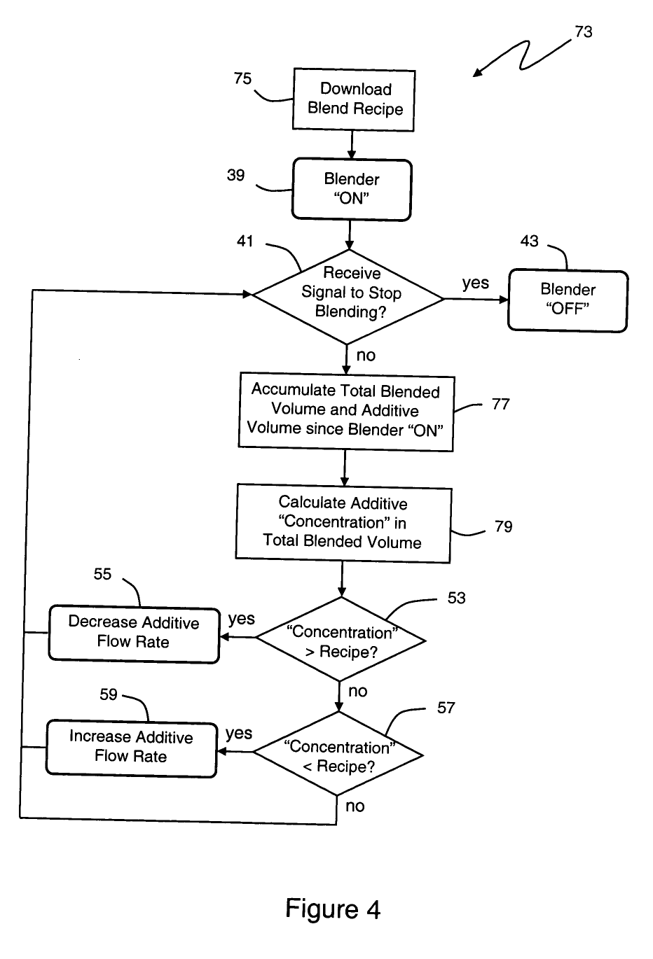

FIG. 4 is a flow chart of blend method 73, which is one embodiment of the present invention that can be used with blender apparatus 61 of FIG. 2. Blocks of method 73 that are the same as blocks in blend method 35 of FIG. 2 are identically labeled. Blend method 73 begins in block 75 where the blend recipe is downloaded to a blender controller 21. After receiving the blend recipe, as in method 35 of FIG. 2, method 73, either from receiving a separated signal or automatically, commands the blender turned “on” in block 39 and determines if a “stop” signal is received in block 41. If the determination is that a “stop” signal is received, in block 43, method 73 commands the blender controller 21 to turn the blender “off”. In this embodiment, method 73 does not send a blend report when the blender is turned “off”. If the determination in block 41 is “no”, method 73 in block 77 commands the blender controller 21 to accumulate and store the total blended volume delivered by the blender and the amount of the additive delivered to the blender since it was turned “on”. For example, blender controller 21 of FIG. 3 would use communication conduits 67, 27 to monitor the outputs of meters 63, and 13 and would accumulate and store the total amount of blended fluid delivered from outlet 19 and the total amount of additive delivered through inlet 5 since the blending process began. Using the accumulated and stored total blended volume and the additive volume of block 77, in block 79 method 73 calculates the concentration of the additive in the total amount of fluid that has been blended since the blender was turned “on” in block 39. In blocks 53 and 57, method 73 determines if the concentration is greater than or less than the recipe concentration, downloaded in block 75. If the concentration of the additive is too great, method 73 appropriately decreases the additive flow in block 55. If the concentration of the additive is too small method 73 increases the additive flow in block 59 or makes no change in the flow of the additive before returning to block 41. Method 73 continuously repeats the steps of determining if a “stop” signal was received, accumulating and storing total blended volume and additive volume since blender was turned “on”, calculating additive concentration in the total blended volume, comparing the additive concentration to the downloaded recipe and, if necessary, and adjusting the flow of the additive until the method in block 41 receives a signal to stop the blending process. In this manner method 73 assures that the concentration of the additive in the total blended volume is the amount specified in the recipe downloaded in block 75 even though at any instant the concentration of the additive in blender output 19 may be greater or less than the desired recipe concentration.

Method 73 of FIG. 4 controls the concentration of the additive by varying the additive flow rate, other embodiments of the invention in blocks 55, 59 can increase or decrease respectively the total flow rate. For example by blender controller 21 of FIG. 3 sending signals to valve 65 through conduit 69, to achieve the desired change in additive concentration, or may vary both the additive flow and total flow to achieve the desired concentration of the additive in the blender output 19 of a batch of fluid from a blender apparatus 61 shown in FIG. 3.

Although method 73 of FIG. 4 calculates and compares the concentration of the additive to the downloaded recipe, it is understood that this is essentially the same as calculating and comparing the base fluid concentration since what is not additive in the blended fluid is base fluid.

FIGS. 1 and 3 show blenders that blend only two fluid components delivered through inlets 3, 5; however, the method of this invention is not limited to controlling blenders for only two fluid components.

The method of the present invention can be used in blend systems designed for a variety of applications including ethanol blending into gasoline, methanol blending into gasoline, methanol/butyl alcohol blending into gasoline, multi-component alcohol blending into gasoline, butane blending into gasoline, ethylhexyl nitrate into diesel fuel, gasoline grade blending (i.e., premium gasoline blended with regular gasoline to make mid-grade gasoline), dimethyl ether blending into diesel fuel, multi-component blending into diesel fuel, multi-component blending into heating oil, oxygenate blending, gasoline into alcohol (for denaturing), RVP blending, etc. Additization can be provided for all of the above blending applications, with provisions for single or multiple additive injection.

While particular embodiments of the present invention have been shown and described, it is apparent that changes and modifications maybe made therein without departing from the invention in its broadest aspects. Various combinations of these embodiments can be made, and the tailoring of the invention to fit the needs of the individual blending system is a feature of the invention.

1. A method for blending two or more fluid components, wherein N is the number of fluid components comprising:
(a) continuously measuring, accumulating and storing flow information on at least N-1 fluid components blended since the start of a blending process,
(b) calculating the concentration of at least N-1 fluid components in the total blended volume of fluid,
(c) continuously comparing the calculated concentration of the fluid components in the total blended volume against a blend recipe for fluid component concentrations, and
(d) continuously adjusting flow rates for at least one fluid component to achieve the desired concentration of each component in the total blended volume, whereby continual control of the concentration of the measured fluid component in the total blended fluid volume.

2. The method of claim 1 further comprises receiving information at the start of the blending process wherein the information includes the blend recipe.

3. The method of claim 1, further comprising initiating a flow of individual components to prescribed blend ratios from the blend recipe.

4. The method of claim 1, further comprising terminating the flow of the components at the end of the blending process.

5. The method of claim 4 wherein the blend process is terminated based on information received at the start of the blending process and during the blending process.

6. The method of claim 1 further comprises receiving information required for the blending process wherein the information is communicated by one or more of the devices selected from the group consisting of a computer, key pad, switch, monitor, sensor mechanical preset, electronic preset, programmable logic controller (PLC), terminal automation system (TAS), and combinations thereof.

7. The method of claim 1 that further comprises communication information about the blending process wherein the information is communicated to one or more of devices selected from the group consisting of a visual signal, audible signal, monitor, computer, PLC, TAS, and combinations thereof.

8. The method of claim 1 wherein fluid components are selected from the group consisting of ethanol, gasoline, methanol, methanol/butyl alcohol, multi-component alcohol, butane, ethyl-hexyl nitrate, diesel fuel, dimethyl ether, heating oil, oxygenate blending, RVP blending, emulsified fuels, hydraulic and gear fluids, and various other industrial fluids, and combinations thereof.

9. The method of claim 1 wherein the fluid component flow is measured using a flow meter.

10. The method of claim 1 wherein the fluid component flow rate is controlled using a control valve.

11. An apparatus for blending two or more fluid components, wherein N is the number of fluid components, comprising:
(a) N inlets that supply the individual fluid components into the blender,
(b) piping for transporting the components through at least one mixing location,and transporting the blended fluid to a blender output;
(c) a means for measuring flow through the piping such that the flow of al least N-1 components can be calculated;
(d) a means for controlling flow rates such that the flow of each fluid component from the N inlets can be independently varied to control the concentration of the individual components in the blended fluid at the output of the blender; and
(e) a blender controller suitable for executing a control method, wherein the controller is adapted to:
(i) receive information to start the blending process,
(ii) continuously measure, accumulate and store flow information since the start of a blending process, and calculating the concentration of at least N-1 fluid components in the total blended volume of fluid,
(iii) continuously compare the calculated concentration of the components in the total blended volume against a recipe for component concentrations, and
(iv) continuously adjust flow rates to achieve and maintain the desired concentration of each component in the total blended volume since the start of the blending process,
resulting in a blending system capable of accurately blending two or more components to a desired blend recipe.

12. The apparatus of claim 11 wherein the information received by the control method to start the blending process includes information about the blend recipe.

13. The apparatus of claim 11 wherein the means for measuring flow are flow meters.

14. The apparatus of claim 11 wherein the means for controlling flow are control valves.

15. A method of blending two or more blend components comprising:
(a) receiving information about a blend recipe into a system control means;
(b) initiating a flow of individual components by the system control means to a prescribed blend ratio from the blend recipe;
(c) continuously measuring flows and calculating concentrations of the individual components in the total blended volume since the initiation of fluid flow;
(d) continuously comparing the calculated concentrations to the concentrations of the blend recipe and continuously adjusting flow rates based upon the comparisons to achieve and maintain the blend recipe concentrations; and
(e) terminating the flow of the components based upon at least one of the following: having reached a total blended volume that is at least the desired batch size, receiving an input signal to terminate blending.
